(19) United States
(12) Patent Application Publication
(10) Pub. No.: US 2009/0068521 A1
(43) Pub. Date: Mar. 12, 2009

(54) Cooling System for a Fuel Cell

(76) Inventors: Martin Buchinger, Wels (AT); Alexander Gonsior, Ansfelden (AT); Mathias Griesbaum, Thalheim/Wels (AT)

Correspondence Address: COLLARD & ROE, P.C., 1077 NORTHERN BOULEVARD, ROSLYN, NY, 11576, US

(21) Appl. No.: 12/226,756

(22) PCT Filed: Mar. 13, 2007
(86) PCT No.: PCT/AT2007/000120

§ 371 Date: Oct. 27, 2008

(30) Foreign Application Priority Data
May 5, 2006 (AT) A783/2006

(51) Int. Cl. H01M 8/04; F28D 15/00

(52) U.S. Cl. 429/26; 165/104.31; 165/104.33

(57) ABSTRACT

The invention relates to a cooling system (13) for a fuel cell (1) having at least one cooler (14), a thermostat (18), a pump (15) for conveying a coolant (17) in a cooling circuit (16), and an equalization container (20), wherein a deionizing resin (19) located in the equalization container (20) is provided for reducing the electric conductivity of the coolant (17), the equalization container (20) being connected to the cooling circuit (16) via at least one duct (21). To establish such a cooling system (13), in which the electric conductivity of the coolant (17) can be kept low continuously in a simple and cost-effective manner, it is provided for the deionizing resin (19) to be arranged in a container (22) in an inner space (24) of the equalization container (20) such that the deionizing resin (19) is at least partially immersed in the coolant (17), and the duct (21) which connects the equalization container (20) and the cooling circuit (16) is freely accessible.

The invention relates to a cooling system for a fuel cell, comprising at least one cooler, a thermostat, a pump for conveying the coolant in a cooling circuit and an equalization container, wherein a deionizing resin located in the equalization container is provided for reducing the electric conductivity of the coolant, the equalization container being connected to the cooling circuit via at least one duct.

The invention further relates to a cooling system for a fuel cell comprising at least one cooler, a thermostat, a pump for conveying a coolant in a cooling circuit, and an equalization container, wherein a deionizing resin is provided for reducing the electric conductivity of the coolant.

The invention relates to a cooling system of a fuel cell, wherein the electric conductivity of the coolant located in the cooling system must be kept as low as possible (<50 μS/cm) so as to prevent secondary reactions in the cooling circuit of the fuel cell.

From DE 699 25 291 T2 a cooling system is known which contains a liquid coolant for cooling a fuel cell. The coolants used for this purpose have an electric conductivity of less than 50 μS/cm. However, the conductivity of coolants in fuel cells shall be kept as low as possible so as to prevent undesired secondary reactions, such as corrosion in the cooling system. In order to attain a preferred conductivity of less than 5 μS/cm, the coolant is exchanged in appropriately short maintenance intervals, or means for maintaining the purity of the coolant are employed.

A preferred means for maintaining the purity of the coolant is an ion exchange resin unit containing a deionizing resin, which unit is installed in the circuit of the cooling system. This is done in a manner that the coolant is pressed through the deionizing resin in the ion exchange resin unit with an appropriately high pumping power. Thereby, the deionizing resin can remove the ionic degradation products from the coolant, whereby the conductivity of the cooling is lowered accordingly.

A disadvantage in this respect is that the ion exchange resin unit is integrated in the cooling circuit of the cooling system and, thus, causes a pressure loss and a high flow resistance, respectively, for the coolant. In order to be able to compensate this high flow resistance, the power of the pump circulating the coolant in the circuit must, e.g., be increased. Thus, the pump has a higher electric power consumption, reducing the effectiveness of the fuel cell system.

It is also disadvantageous that the ion exchange resin unit constitutes an additional component in the cooling system, thereby increasing the number of potential leakage sites within the cooling system.

A further disadvantage consists in that for exchanging the deionizing resin in the ion exchange resin unit, cooling and, thus, the operation of the fuel cell must be interrupted.

JP 2003-346845 A describes a cooling system for a fuel cell, wherein the deionizing resin is provided in an equalization container externally of the cooling circuit in a bypass. For moving a part of the coolant through the deionizing resin, additional pumps are arranged which reduce the total effectiveness of the fuel cell system.

JP 2005-032654 A also describes a fuel cell system, wherein deionizing of the coolant is effected by the aid of additional pumps. Here, too, the additional components required for deionization reduce the effectiveness of the fuel cell system.

Therefore, it is an object of the invention to provide a cooling system in which the electric conductivity of the coolant is continuously kept low in a simple and cost-effective manner.

The object of the invention is achieved in that the deionizing resin is arranged in a container in an inner space of the equalizing container such that the deionizing resin is at least partially immersed in the coolant, and the duct which connects the equalization container and the cooling circuit is freely accessible. Here it is advantageous that by the deionizing resin in the equalization container, an additional pressure loss, or an additional flow resistance, respectively, in the cooling circuit is prevented without adversely affecting the effect of the deionizing resin. Thus, only a low power of the pump is required, whereby the effectiveness of the fuel cell system is increased since the energy consumption of the fuel cell itself is lowered. Deionization of the coolant is achieved in an advantageous manner in that due to the deionizing resin, the coolant in the equalization container has a substantially lower concentration of conductive ions than the coolant in the cooling circuit. This results in the concentration differences being equalized by diffusion processes, whereby the conductivity of the coolant can be kept at the required level over a substantially longer period of time. Likewise, it is advantageous that in this way at least one additional component for deionizing the coolant within the cooling circuit, by which the number of the potential leakage sites or leaking sites would increase, is avoided. This construction prevents the container of the deionizing resin from negatively influencing the flow rate of the duct. Likewise, it is thereby rendered possible to simply exchange the container, and the deionizing resin in the container, respectively, during the operation of the fuel cell without interrupting the cooling and, thus, the operation of the fuel cell.

If the duct is connected at a suction side of the pump of the cooling circuit, it is achieved in an advantageous manner that due to a lower pressure on the suction side compared to the pressure side of the pump, the equalization of the concentration differences is improved.

If the container is fastened by a screw-type closure of a filler opening of the equalization container, the latter can be exchanged in a particularly rapid and simple manner.

The object of the invention is also achieved in that the deionizing resin is provided in a container in a receiving chamber within the cooling circuit. Here it is advantageous that the coolant flows evenly through the receiving chamber, whereby the flow resistance for the coolant in the receiving chamber substantially does not affect the effectiveness of the fuel cell system.

Advantageously, the container is fastened to the receiving chamber via at least one strut in such a way that the coolant will flow around the container.

In this respect, it is advantageous if the container is arranged and fastened in the middle of the receiving chamber.

If the container is of an appropriate streamlined design, a lower flow resistance will result for the coolant in the receiving chamber.

When at least one strut has a cavity connected to the inner space of the container, the container can be filled with deionizing resin during operation of the fuel cell.

According to a further characteristic feature of the invention, at least one degassing duct is provided which connects the cooling circuit with the equalization container.

This at least one degassing duct forms a secondary circuit together with the duct and the equalization container, thereby accelerating the equalization of the differences in the concentrations between the coolant in the equalization container and the coolant in the cooling circuit.

By the secondary circuit formed via the degassing duct, a partial flow of the coolant is conveyed into the equalization container. In this way, in addition to the diffusion processes the secondary circuit will cause mixing of the coolant in the equalization container, which coolant has a very low concentration of conductive ions, with the coolant in the cooling circuit which has a higher concentration of conductive ions, whereby the acceleration of the equalization of the concentration differences is attained.

Via a pressure-relief safety means or venting means provided in the equalization container, in particular a pressure-relief valve, the gases delivered via the degassing duct from the cooling circuit and gathered in the equalization container can be discharged. Likewise, an overpressure in the equalization container resulting from an expansion of the coolant can be equalized.

Advantageously, the deionizing resin consists of basic anionic resins and/or mixed bed resins.

The container for the deionizing resin preferably consists of a material which is permeable to the coolant, which, in particular, is also resistant to the coolant, in particular of polypropylene or polyethylene. Thereby, the anions and the cations, which cause the conductivity, can be continuously withdrawn from the coolant, resulting in a continuous deionization of the coolant. Likewise, in terms of size and shape, the container is variably adjustable to the requirements of the equalization container and the cooling system, respectively.

The present invention will be explained in more detail by way of the enclosed schematic drawings.

Therein,

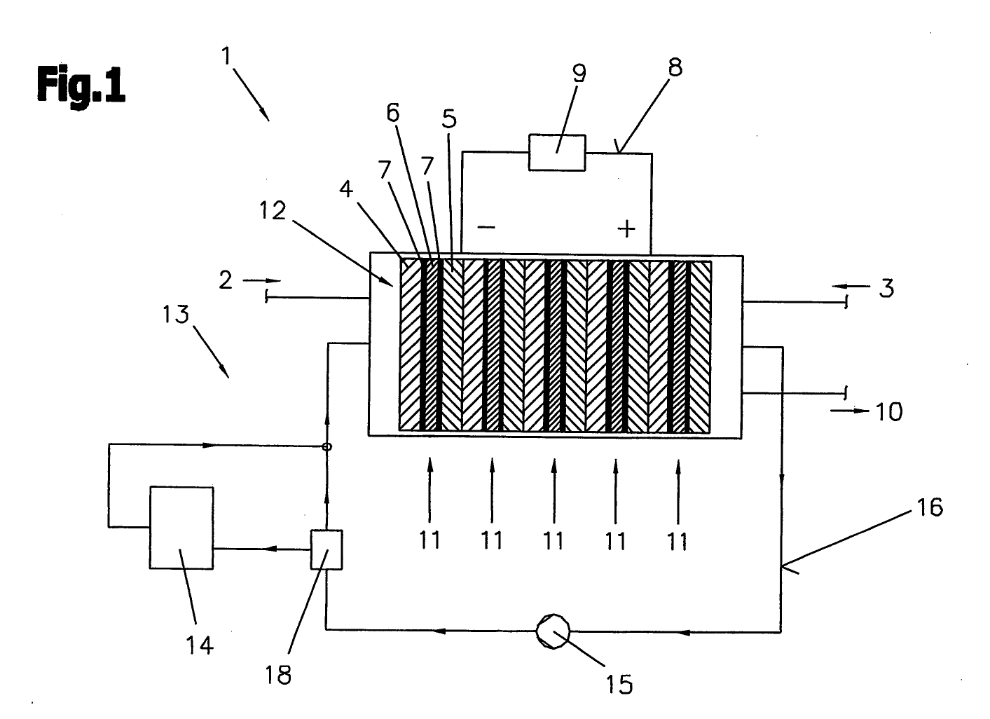

FIG. 1 shows the schematic set-up of a fuel cell;

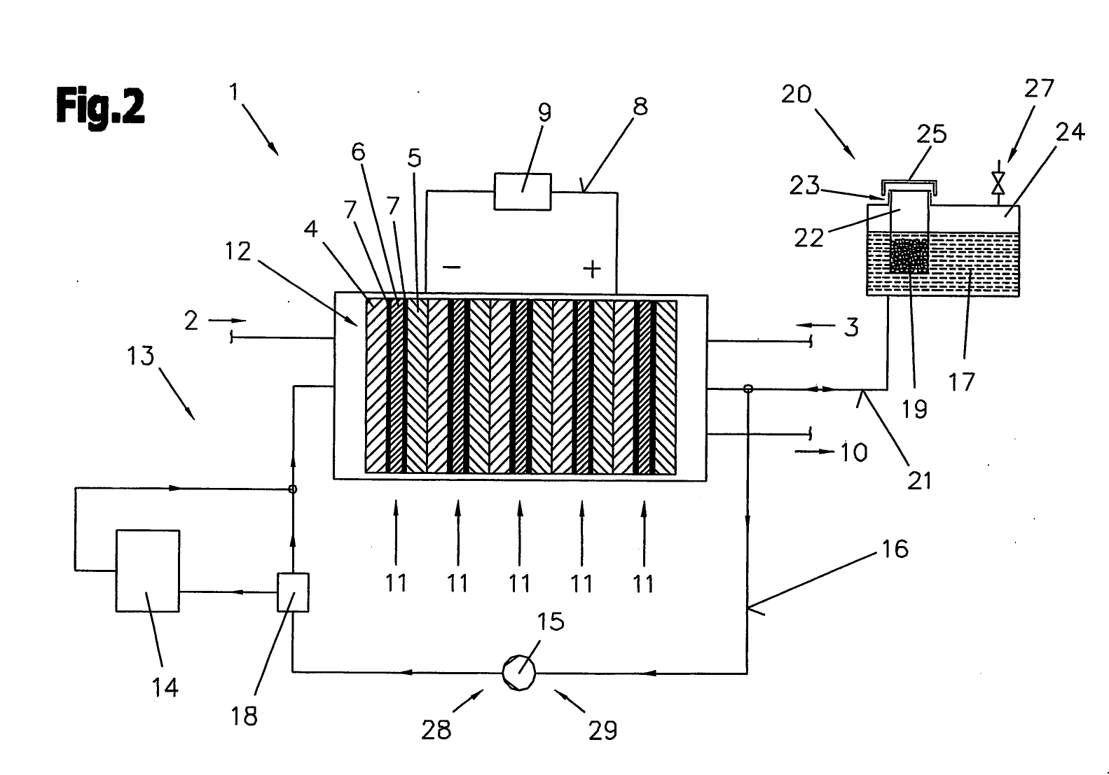

FIG. 2 shows the schematic set-up of a fuel cell with the cooling system according to the invention;

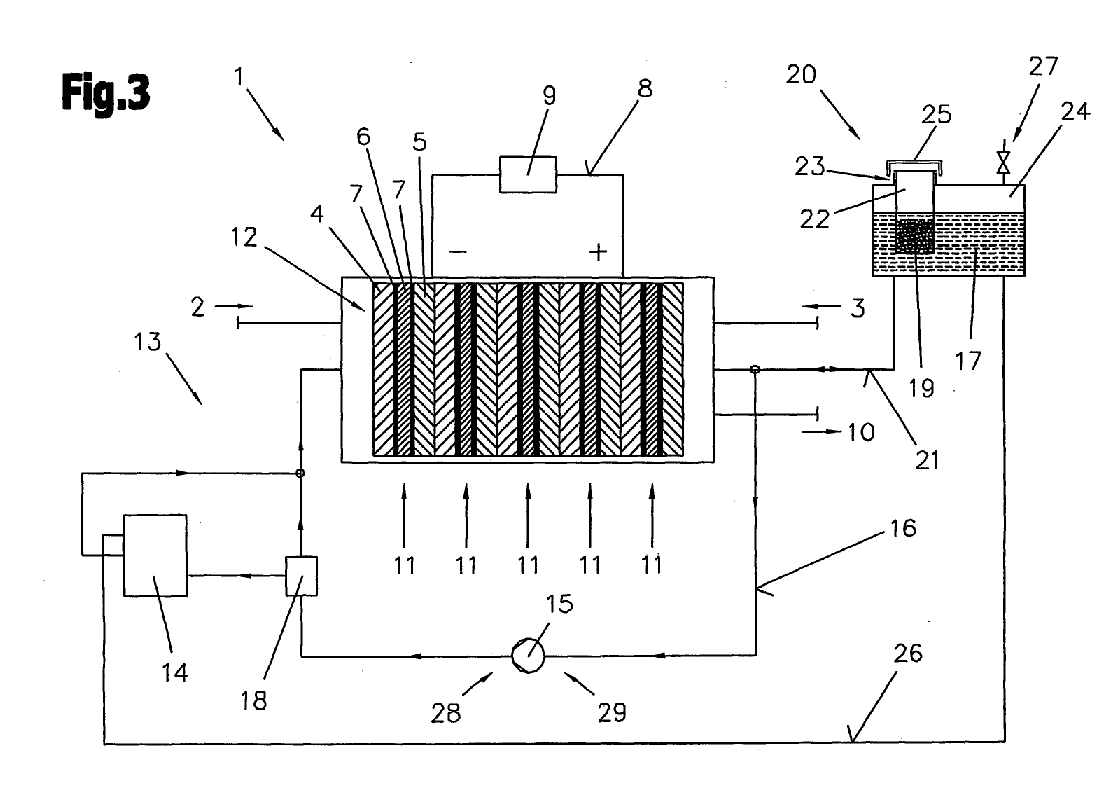

FIG. 3 shows the schematic set-up of a fuel cell with a further variant of the cooling system according to the invention;

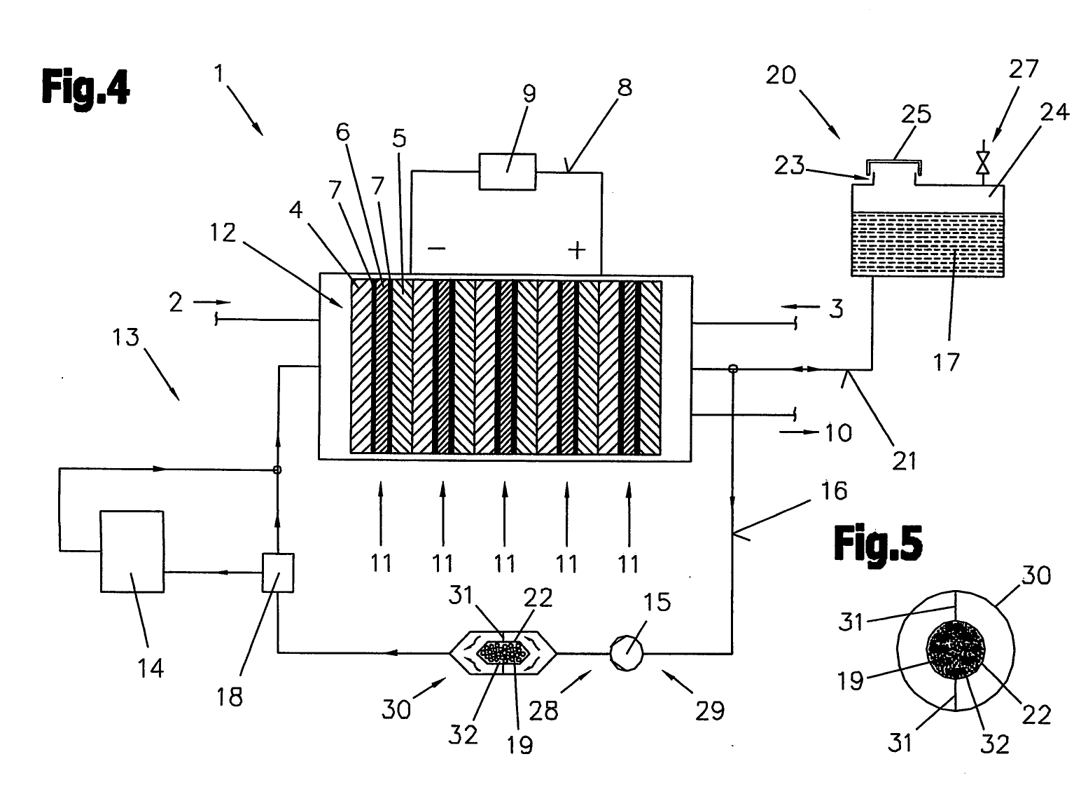

FIG. 4 shows the schematic set-up of a fuel cell with a third variant of the cooling system according to the invention; and

FIG. 5 shows a section through a receiving chamber.

At first, it is mentioned that equal parts of the exemplary embodiment have the same reference numbers.

In FIG. 1, a fuel cell 1 for generating current from hydrogen 2 and oxygen 3 or air, respectively, is shown.

In general, fuel cells 1 are electrochemical current producers which generate electric current directly from a chemical reaction. This is effected by reversing the electrolytic decomposition of water, in which the gases hydrogen 2 and oxygen 3 are formed by means of a current flow.

This means that in the fuel cell 1, hydrogen 2 reacts with oxygen 3, whereby current is generated. For this purpose, hydrogen 2 is fed to an anode 4, and oxygen 3 is fed to a cathode 5, the anode 4 and the cathode 5 being separated by an electrolyte 6. Moreover, the anode 4 and the cathode 5 are coated with a catalyst 7, mostly made of platinum, at their sides facing the electrolyte 6. By this, the hydrogen 2 can react with the oxygen 3, this occurring in two separate single reactions at the two electrodes, the anode 4 and the cathode 5.

The anode 4 is supplied with hydrogen 2 which reacts at the catalyst 7 and splits into one hydrogen molecule and two hydrogen atoms each. One hydrogen atom has two components, a negatively charged electron and a positively charged proton. Each hydrogen atom discharges its electron. The positively charged protons diffuse through the electrolyte 6, which is impermeable to the negatively charged electrons, to the cathode 5.

At the same time at which hydrogen 2 is fed to the anode 4, oxygen 3 is supplied to the cathode 5. The oxygen molecules react at the catalyst 7 and each split into two oxygen atoms which deposit at the cathode 5.

Thus, the positively charged protons of the hydrogen 2 as well as the oxygen atoms are deposited at the cathode 5, and at the anode 4 the negatively charged electrons of the hydrogen 2 are deposited. This causes a so-called electron deficit at the cathode 5, and a so-called electron excess at the anode 4. From this, there results a negative charge at the anode 4 and a positive charge at the cathode 5. The anode 4 thus corresponds to a negative pole (−) and the cathode 5 to a positive pole (+).

Now, if the anode 4 and the cathode 5 are connected to an electric conductor 8, as a consequence of the difference in potential, the electrons will migrate via the electric conductor 8 from the anode 4 to the cathode 5. This means, an electric direct current is flowing via a consumer 9 connected to the conductor 8. The consumer 9 may, e.g., also be formed by a battery, which stores the current produced, or by an inverter, which converts the DC produced into AC.

Two electrons which have migrated via the electric conductor 8 from the anode 4 to the cathode 5 are each taken up by an oxygen atom in the cathode 5 and become twofold negatively charged oxygen ions. These oxygen ions unite with the positively charged protons of the hydrogen 2 which have diffused through the electrolyte 6 from the anode 5 onto the cathode 5, to water 10. The water 10 is discharged at the cathode 5 as a so-called final reaction product.

That is, in a cell 11 of the fuel cell 1, hydrogen 2 reacts with oxygen 3, whereby current is produced. A cell 11 is formed by anode 4, cathode 5, electrolyte 6 and catalyst 7. A combination of several cells 11 in series connection is generally called a stack 12.

Due to the reaction of hydrogen 2 with oxygen 3 in the individual cells 11 of a stack 12, heat forms which must be conducted away. This is effected via a cooling system 13 which, in its simplest form, consists of a cooler 14, a pump 15 and a cooling circuit 16. The pump 15 pumps a coolant 17 provided in the cooling circuit 16 through the stack 12 of the fuel cell 1, e.g. in the direction according to the arrows. By this, the coolant 17 withdraws the heat from the stack 12 by taking up the heat by means of the coolant 17. The cooler 14 in the cooling circuit 16 in turn withdraws the heat from the coolant 17 and delivers it to the ambient air so that the coolant 17 again is capable of withdrawing the heat from the stack 12. The cooling circuit 16 can also be regulated such that the coolant 17 will only flow through the cooler 14 if the coolant 17 has a certain temperature. This regulation is accordingly effected via a thermostat 18.

Since the cooling system 13 is a component of the fuel cell 1, it is subjected to the voltages which are generated by the cells 11. Thus, it is important that no substantial current flow occurs between the cells 11 through the coolant 17. Therefore, for instance, completely demineralized water (deionized water) or a mixture of ethylene glycol and water with a low electric conductivity is used as the coolant 17.

The electric conductivity of the coolant 17 is reduced by the use of a deionizing resin 19 which, e.g., consists of a basic anion resin or mixed bed resin. The deionizing resin 19 has the effect that electrically conductive ions (anions and cations) delivered into the coolant 17 by diverse procedures (corrosion, oxidation, . . . ) will be absorbed. Thus, the conductivity of the coolant 17 preferably can be kept below 5 μS/cm, thereby preventing parasitic currents which would downgrade the effectiveness, and secondary reactions which would cause corrosion in the cooling system 13.

Thus, for instance, the deionizing resin 19 is integrated into an ion exchange resin unit as is known from DE 699 26 291 T2, the ion exchange resin unit being flowed through by the coolant 17. In doing so, the electrically conductive ions (anions and cations) taken up from the cells 11 are absorbed from the coolant 17 by the deionizing resin 19. Thus, the conductivity of the coolant 17 can preferably be maintained below 5 μS/cm, thereby preventing parasitic currents which would down-grade the effectiveness, and secondary reactions which would cause corrosion in the cooling system 13.

According to the invention, it is now provided for the deionizing resin 19 to be integrated in an equalization container 20. For this purpose, the equalization container 20 is connected to the cooling circuit 16 via a duct 21. Thus, the deionizing resin 19 is not directly integrated in the cooling circuit 16, whereby the former does not cause a high flow resistance to the coolant 17, by which, however, the conductivity of the coolant 17 is continuously kept low.

In FIG. 2, the cooling system 13 according to the invention with the equalization container 20 is illustrated. According to the invention, the deionizing resin 19 is located in the equalization container 20, the deionizing resin 19 being filled into a container 22 or into a bag or small bag. Preferably, the container 22 is fastened in the equalization container 20 such that the container 22 is introduced into an inner space 24 of the equalization container 20 through a filler opening 23 of the equalization container 20. At one end thereof, the container 22 has a projection by means of which the container 22 rests on the rim of the filler opening 23. Thus, the filler opening 23 is, e.g., closed by the container 22. The filler opening 23 may, however, also be closed by a screw-type closure 25. If, for instance, such a screw-type closure 25 is used, the end of the container 22 with the projection may be configured to be open so that the deionizing resin 19 possibly may also be changed or refilled in a simple manner.

By such a fastening of the container 22 which may also be called “floating”, it will be ensured that the connection from the inner space 24 of the equalization container 20 to the duct 21 will always be freely accessible, so that a permanent connection will be present between the equalization container 20 and the cooling circuit 16. Likewise, it is thereby ensured that the deionizing resin 19 will always be at least partially or completely immersed in the coolant 17 so that the entire deionizing resin 19 present in the container 22 will be utilized. For this purpose, the size of the equalization container 19 will be adapted accordingly so that even a change in the volume of the coolant 17 can be equalized in the equalization container 20.

According to the invention, the container 22 is made of materials resistant to demineralized water and to coolant, such as polyethylene (PE) or polypropylene (PP), which are permeable to the coolant 17. The material will be formed, e.g., by a woven fabric or a meshwork having an appropriate mesh width, so that the deionizing resin 19 will not leave the container 22 and the coolant 17 will be able to flow through the container 22. Likewise, it is possible for the container 22 to have small holes through which the coolant 17 will get into the container 22, while the deionizing resin 19 will always remain in the container 22. By such a construction, the deionizing resin 19 can be integrated into the cooling system 13 in a simple manner, without great expenditures and at reasonable costs, since high demands, such as a pressure resistance, are not made on the container 22.

Thus, the deionizing resin 19 will absorb the electrically conductive ions of the coolant 17 which nearly stands still within the inner space 24 of the container 22, so that the coolant 17 will only have a very low concentration of ions and a very low conductivity, respectively. This is effected by diffusion processes between the deionizing resin 19 and the coolant 17.

The coolant 17 in the cooling circuit 16, however, has a high concentration of ions, since electrically conductive ions are constantly taken up by the cells 11 of the stack 12. In principle, the coolant 17 in the cooling circuit 16 will hardly ever get into the equalization container 20, since it is continuously circulated in the cooling circuit 16 by the pump 15. Yet, the equalization container 20 does, of course, also serve the purpose of equalizing the correspondingly increased volume of the coolant 17 when it heats up. If the volume of the equalization container 20 were not sufficient for this purpose, the equalization container 20 will have a pressure-relief safety means 27 or a venting means, i.e. a pressure-relief valve, or discharge valve, respectively. The high concentration differences present between the coolant 17 in the equalization container 20 and the coolant 17 in the cooling circuit 16 result in diffusion processes. The latter have the effect that the concentration differences are equalized via the duct 21 and, thus, the conductivity of the coolant 17 also within the cooling circuit 16 is lowered to the required value. These diffusion processes are assisted by the pressure gradient between a pressure side 28 and a suction side 29 of the pump 15, by the equalization container 20 being connected at the suction side 29 to the cooling circuit 16. Thus, there exists at least a slight negative pressure at the suction side 29, which is equalized by the coolant 17 from the equalization container 20. As a result, the coolant 17 having a very low concentration of ions from the equalization container 20 blends in the cooling circuit 16 with the coolant 17 having a higher concentration of ions, thereby improving the lowering of the conductivity. The pressure gradient required results from the pressure loss in the stack 12.

In practical applications, the length as well as the cross-section of the duct 21 in most instances has no substantial influence for lowering of the conductivity of the coolant 17. The length of the duct 21 is, e.g., from 10 cm to 50 cm at an inner diameter of approximately 10 mm to 20 mm.

The time factor for the diffusion procedures or for equalizing the concentration differences, respectively, substantially has no influence, since when no deionizing resin 19 is used, the conductivity of the coolant 17 will exceed a limit value (e.g. 50 μS/cm) only after approximately one month. Thus, the use of the deionizing resin 19 has the effect that the conductivity of the coolant 17 is continuously kept low and the coolant 17 will have to be exchanged only after a few years.

Equalizing the concentration differences can be enhanced by the use of a degassing duct 26, as schematically illustrated in FIG. 3. The degassing duct 26 connects the cooler 14 with the equalization container 20 and has the function of removing reaction gases accumulated in the cooling circuit 16. The reaction gases, hydrogen 2 and oxygen 3, will get into the cooling circuit 16 since the cells 11 are not absolutely tight, or they are also formed as the product of secondary reactions in the cooling circuit 16. The reaction gases preferably collect at the exit of the cooler 14 where they are transported together with a part of the coolant 17 from the cooling circuit 16 via the degassing duct 26 into the inner space 24 of the equalization container 20. This partial flow via the degassing duct 26 into the equalization container 20 amounts to approximately five to ten percent of the flow in the cooling circuit 16. If the gas volume collected in the equalization container 20 becomes too large, or if the pressure of the reaction gas become too high, respectively, the reaction gases will be discharged from the equalization container 20 via the pressure relief safety device 27, or the pressure relief or discharge valve, respectively.

The degassing duct 26 increases the equalization of the concentration differences between the coolant 17 in the equalization container 20 and the coolant 17 in the cooling circuit 16 insofar as a so-called secondary circuit forms. Accordingly, this secondary circuit is formed by the degassing duct 26, the equalization container 20 with the deionizing resin 19, and the duct 21. Via the secondary circuit, the coolant 17 from the cooling circuit 16, which exhibits a high concentration of ions, is blended with the coolant 17 in the equalization container 20, which has a low concentration of ions. Likewise, the mixed coolant 17 in the equalization container 20 automatically reaches the cooling circuit 16 via the duct 21, resulting in a circulation and lowering the conductivity. Thus, in addition to the diffusion processes, in particular via the duct 21, for equalizing the differences in concentration via the degassing duct 26 the coolants 17 having the different concentrations of ions are blended, thereby increasing the concentration equalization. Since the secondary circuit is substantially independent of the cooling circuit 16, the flow resistance in the cooling circuit 16 is not increased. Hence follows that the output of the pump 15 need not be increased in order to ensure cooling of the stack 12 and, thus, the net energy production of the fuel cell system is maintained.

The reason why the efficiency and the flow resistance are not downgraded by the container 22, is also that the container 22 made of a woven fabric or of a meshwork is substantially flexible. Therefore, the container 22 is able to move substantially freely within the inner space 24 of the equalization container 20, and, thus, has no or only an insignificant influence on the flow resistance in the secondary circuit. Of course, it is always ensured that the deionizing resin 19 is completely or at least partially immersed in the coolant 17.

According to the invention, the container 22 which contains the deionizing resin 19 may also be directly arranged in the cooling circuit 16, without increasing the flow resistance and, thus, negatively affecting the efficiency of the fuel cell system. This is, e.g. achieved in that the container 22 preferably has a streamlined design according to FIGS. 4 and 5. Accordingly, the cooling circuit 16 has a receiving chamber 30 in which the container 22 comprising the deionizing resin 19 is arranged. The container 22 may, e.g., be connected to the receiving chamber 30 via two struts 31. This may, of course, also be achieved via more or fewer struts 31. Due to such a fastening and configuration of the container 22, substantially no increased pump output is required, since the flow resistance is extremely low and the coolant 17 can flow around the container 22 according to the illustrated arrows in the receiving chamber 30. This is also assisted in an advantageous manner by the shape of the receiving chamber 30 according to FIG. 4 in that the latter corresponds to the streamlined shape of the container 22 and is configured in correspondence with the container 22, respectively.

According to the invention, the receiving chamber 30 is integrated in the cooling circuit 16. Preferably, it is arranged on the pressure side 28 of the pump 15, whereby the coolant 17 will flow through the receiving chamber 30 at an at least slightly elevated pressure. This results in the flow resistance through the container 22 being negligibly low.

For exchanging the deionizing resin 19 present in the container, at least one strut 31 may, e.g., have a cavity (not illustrated), which is connected to the inner space 32 of the container 22. Preferably, two struts 31 each have a cavity, wherein the deionizing resin 19 can be filled into the inner space 32 of the container 22 via one cavity, and the deionizing resin 19 can be discharged or sucked off from the inner space 32 of the container 22 via the other cavity. Thus, also in this case for an exchange of the deionizing resin 19, an interruption of the operation of the fuel cell 1 is not required, since the deionizing resin 19 can be refilled from the outside. Likewise, a continuous deionization of the coolant 17 is thereby ensured.

The deionization of the coolant 17 substantially corresponds to the function already previously described and therefore is not discussed in more detail. Likewise, the detailed description of the cooling system 13 and its components, such as the container 22 etc., can be taken from the previous text. Thus, also the use of the degassing duct 26 is possible.

1-17. (canceled)

18: A cooling system (13) for a fuel cell (1), comprising at least one cooler (14), a thermostat (18), a pump (15) for conveying a coolant (17) in a cooling circuit (16) and an equalization container (20), wherein for reducing the electric conductivity of the coolant (17), a deionizing resin (19) is provided which is located in the equalization container (20), the equalization container (20) being connected to the cooling circuit (16) via at least one duct (21), wherein the deionizing resin (19) is located in a container (22) made of a material permeable to the coolant (17), which container is arranged in an inner space (24) of the equalizing container (20) such that the deionizing resin (19) is at least partially immersed in the coolant (17), and the duct (21) which connects the equalization container (20) and the cooling circuit (16) is freely accessible, so that a permanent connection is present between the equalization container (20) and the cooling circuit (16) so that the deionizing resin (19) will reduce the electric conductivity of the coolant (17) by diffusion processes occurring between the deionizing resin (19) and the coolant (17).

19: The cooling system (13) according to claim 18, wherein the duct (21) is connected to a suction side (29) of the pump (15) of the cooling circuit (16).

20: The cooling system (13) according to claim 18, wherein the container (22) is fastened by means of a screw-type closure (25) of a filler opening (23) of the equalization container (20).

21: A cooling system (13) for a fuel cell (1) comprising at least one cooler (14), a thermostat (18), a pump (15) for conveying a coolant (17) in a cooling circuit (16), and an equalization container (20), wherein a deionizing resin (19) is provided for reducing the electric conductivity of the coolant (17), wherein the deionizing resin (19) is located in a container (22) made of a material permeable to the coolant (17), which container (22) is arranged in a receiving chamber (30) in the cooling circuit (16) so that the deionizing resin (19) will reduce the electric conductivity of the coolant (17) by diffusion processes occurring between the deionizing resin (19) and the coolant (17).

22: The cooling system (13) according to claim 21, wherein the container (22) is fastened to the receiving chamber (30) via at least one strut (31) such that the coolant (17) will flow around the container (22).

23: The cooling system (13) according to claim 22, wherein the container (22) is arranged and fastened in the middle of the receiving chamber (30).

24: The cooling system (13) according to claim 21, wherein the container (22) has a streamlined design.

25: The cooling system (13) according to claim 21, wherein the receiving chamber (30) is configured in correspondence with the container (22).

26: The cooling system (13) according to claim 21, wherein at least one strut (31) has a cavity connected to the inner space (32) of the container (22).

27: The cooling system (13) according to claim 18, wherein at least one degassing duct (26) is provided which connects the cooling circuit (16) to the equalization container (20).

28: The cooling system (13) according to claim 27, wherein at least one degassing duct (26) connects the cooler (14) to the equalization container (20).

29: The cooling system (13) according to claim 27, wherein the at least one degassing duct (26) forms a secondary circuit in combination with the duct (21) and the equalization container (20).

30: The cooling system (13) according to claim 18, wherein the equalization container (20) is equipped with a pressure relief means (27) or a venting means.

31: The cooling system (13) according to claim 30, wherein the pressure relief means (27) is formed by a pressure relief valve.

32: The cooling system (13) according to claim 18, wherein the deionizing resin (19) consists of basic anion resins and/or mixed bed resins.

33: The cooling system (13) according to claim 18, wherein the container (22) is made of a material which is resistant to the coolant (17), in particular of polypropylene or polyethylene.
